(19) United States
(12) Patent Application Publication
(10) Pub. No.: US 2025/0326162 A1
(43) Pub. Date: Oct. 23, 2025

(54) SYSTEMS AND METHODS FOR PRODUCING A RE-PURPOSABLE BIODEGRADABLE CONTAINER

(71) Applicant: Anthe Poulos, Flushing, NY (US)

(72) Inventor: Anthe Poulos, Flushing, NY (US)

(73) Assignee: Anthe Poulos, Flushing, NY (US)

(21) Appl. No.: 19/186,342

(22) Filed: Apr. 22, 2025

Related U.S. Application Data
(60) Provisional application No. 63/637,178, filed on Apr. 22, 2024.

(51) Int. Cl. B29B 17/04; B29K 91/00; B29L 31/00; C11C 5/00; C11C 5/02

(52) U.S. Cl. CPC B29B 17/04; C11C 5/006; C11C 5/023; B29B 2017/0496; B29K 2091/00; B29K 2995/006; B29L 2031/712

(57) ABSTRACT

Disclosed herein are systems and methods for creating and repurposing a container. The system can include a mold comprising a core, a cover and a ring. The cover can comprise a raised surface at a first end and a hole at a second end. The ring can have an annular shape defining an opening and can be configured to surround the core. The ring can further comprise a groove configured to receive the raised surface. The method for creating the container can comprise assembling a mold, heating a mixture comprising at least candle wax to form the material, inserting the material into the mold, waiting for the material to cure, decoupling the cover from the mold and removing the container from the mold. The method for repurposing the container can comprise melting the container into a liquid, transferring the liquid into a vessel and waiting for the liquid to cure.

### TECHNICAL FIELD

The present disclosure relates to systems and methods for producing a biodegradable container that can be repurposed into another product.

### BACKGROUND

Compostable products are often touted as a sustainable alternative to traditional products made of plastic and other non-sustainable materials. Most compostable products do not need to go to a landfill, although some compostable plastics must be sent to a commercial composting facility.

Compostable products (and packaging) can take six months to decompose fully, even under the right environmental conditions.

Compostable products will leave no trace once decomposition is complete. It is part of the design of a compostable product for it to be beneficial to the soil and environment during the decomposition process.

Opting for a compostable product means less waste will go into local landfills and less pollution will go directly into the environment. In addition, as these types of products traditionally take less energy to produce, fewer harmful emissions will be generated. More composting also means fewer fertilizers and harmful chemicals are needed.

Biodegradable products and packaging are another alternative to plastic. Products made from plant materials and non-synthetic materials are biodegradable and generally decompose within a few weeks or months. A biodegradable product requires less energy to make, fewer emissions will be released during the manufacturing process, and there's also the benefit of less waste.

Some compostable and biodegradable products can be reused or repurposed into other products. A reused product is one that can be used for the same purpose without it having to be replaced. A repurposed product is one that can be used for a different purpose without it having to be purchased. In both cases, fewer products will be made and less will end up in the environment. Therefore, reused and repurposed products are better compared to those products made to only biodegrade or decompose.

In particular, repurposed products are better than compostable, biodegradable, and even recyclable products, for the following reasons:
i) Reduces waste: repurposing reduces waste and conserves resources.
ii) Creates less pollution: repurposing doesn't create pollution.
iii) Saves energy and money: recycling requires a large amount of energy and money, while repurposing preserves the embodied energy.
iv) Reduces air and water pollution: repurposing creates less air and water pollution than recycling.

In conclusion, a product that can be repurposed before being composted, biodegraded, or recycled is more beneficial for the environment and potentially more desirable for consumers than a product that can only be composted, biodegraded, or recycled.

### SUMMARY

The present disclosure seeks to address this problem of waste and pollution for the environment by disclosing embodiments that are both biodegradable and re-purposable in comparison to products that are only biodegradable, compostable, or recyclable.

Candle wax can be the main and active ingredient used to make the containers according to some embodiments of the present disclosure. Candle wax is traditionally used to make candles and the most common candle waxes are paraffin wax, beeswax, soy wax, candelilla wax, carnauba wax, and coconut wax.

The candle wax can be heated and melted down to a liquid form. Then, the liquid candle wax can be introduced into a blow mold, injection mold, compression mold, rotational mold, or other mold based on the specification for that particular mold.

Different shaped molds can create different shaped products. In certain embodiments the product can be a container, for example, a biodegradable container for storing food. The candle wax in the mold can revert to a solid state and the candle wax can take the shape of the mold. The container can be demolded or released from the mold and utilized for its intended purpose.

After being used for its intended purpose, the product can be repurposed into a candle. The product can be melted down to liquid form, liquid candle wax. The liquid candle wax can be transferred into a vessel or container. A wick can be submerged into the liquid candle wax and down the center of said vessel. After 8-12 hours, the liquid candle wax may have cured and the user can have a fully functional candle they may use.

The embodiments disclosed herein each have several aspects, no single one of which is solely responsible for the disclosure's desirable attributes. Without limiting the scope of this disclosure, its more prominent features will now be briefly discussed. After considering this discussion, and particularly after reading the section entitled “Detailed Description” one will understand how the features of the embodiments described herein provide advantages over existing systems, devices and methods for re-purposable biodegradable containers.

The following disclosure describes non-limiting examples of some embodiments. For instance, other embodiments of the disclosed systems and methods may or may not include the features described herein. Moreover, disclosed advantages and benefits can apply only to certain embodiments and should not be used to limit the disclosure.

A re-purposable container system is provided. The system can include a container, a vessel that can be configured to house the container and a wick that can be releasably coupled to the vessel and can be configured to release from the vessel and submerge in the container while the container is in a liquid state. The vessel can comprise a bottom piece which can comprise one or more recesses configured to receive the container while the container is in the liquid state and a top piece which can abut the bottom piece.

In some embodiments of the present disclosure, the container, the vessel and the wick can comprise a biodegradable material.

In some embodiments of the present disclosure, the base can comprise at least one of a fire-resistant material and a fire-resistant additive.

In some embodiments of the present disclosure, the base can comprise a leak-resistant material.

In some embodiments of the present disclosure, the vessel can be configured to receive the container while the container is in the liquid state and to house the container in the liquid state while the container in the liquid state cures.

In some embodiments of the present disclosure, the container can be in a non-liquid packaging state, prior to being in the liquid state.

In some embodiments of the present disclosure, the vessel can be configured to package the container in the packaging state.

In some embodiments of the present disclosure, the material can comprise a food-safe material suitable for packaging an edible product.

In some embodiments of the present disclosure, the container can comprise a first piece and a second piece and the container can further comprise an adhesive which can comprise a first adhesive end coupled to the first piece and a second adhesive end coupled to the second piece and can be configured as a hinge such that the first piece and the second piece can be configured to move between a closed position and an open position.

In some embodiments of the present disclosure, the container can comprise a diluting agent.

A method for repurposing a re-purposable container is provided. The method can comprise melting the re-purposable container into a liquid, transferring the liquid into a vessel and waiting for the liquid to cure.

In some embodiments of the present disclosure, the method can further comprise submerging a wick in the liquid.

In some embodiments of the present disclosure, the method can further comprise igniting the wick.

In some embodiments of the present disclosure, the method can further comprise treating a base of the vessel with a solution comprising a fire-resistant additive.

In some embodiments of the present disclosure, the method can further comprise treating a base of the vessel with a solution comprising a leak-resistant additive.

In some embodiments of the present disclosure, the re-purposable container can be in a non-liquid packaging state prior to melting into the liquid state.

In some embodiments of the present disclosure, the method can further comprise packaging the re-purposable container in the packaging state with the vessel.

In some embodiments of the present disclosure, the re-purposable container can comprise a food-safe material suitable for packaging an edible product.

In some embodiments of the present disclosure, the container can comprise a first piece and a second piece and the container can further comprise an adhesive which can comprise a first adhesive end coupled to the first piece and a second adhesive end coupled to the second piece and can be configured as a hinge such that the first piece and the second piece can be configured to move between a closed position and an open position, and the method can further comprise storing the edible product in the container in the open position and transitioning the container between the open position and the closed position.

In some embodiments of the present disclosure, the method can further comprise treating the container with a diluting agent.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawing, can be arranged, substituted, combined, and designed in a wide variety of different configurations, all of which are explicitly contemplated and make part of this disclosure.

FIG. 1 shows example embodiments of parts of a mold that can be configured for making a container;

FIG. 2 shows a top view of the example embodiments of the parts of FIG. 1;

FIG. 3 shows an example embodiment of a mold that can be configured for making a container;

FIG. 4 shows an example embodiment of the container cured on the core of the mold with the cover of the mold removed;

FIG. 5 shows an example embodiment of the container of FIG. 4 removed from the mold;

FIG. 6 shows an example embodiment of a container repurposed into a candle;

FIG. 7 shows an example embodiment of a base of a vessel with three recesses;

FIG. 8 shows an example embodiment of the vessel of FIG. 7 with candle wax in each of the three recesses;

FIG. 9 shows an example embodiment of the vessel of FIG. 7 and FIG. 8 with a top;

FIG. 10 shows a flow chart of an example embodiment of a method for making a container;

FIG. 11 shows a flow chart of an example embodiment of a method for repurposing a container.

### DETAILED DESCRIPTION

Generally described, embodiments of the present disclosure provide systems and methods relating to producing re-purposable, biodegradable snack containers providing enhanced characteristics relative to existing systems and methods for producing snack containers.

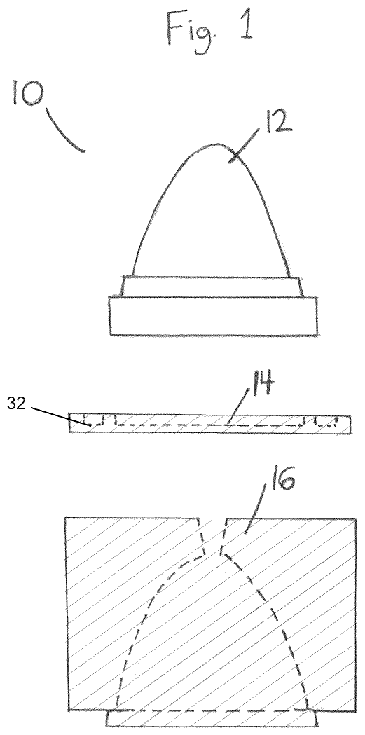

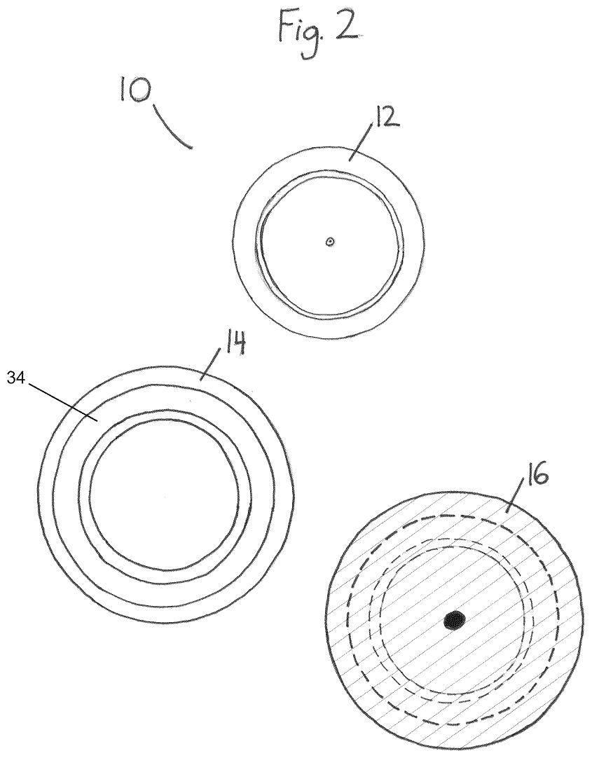

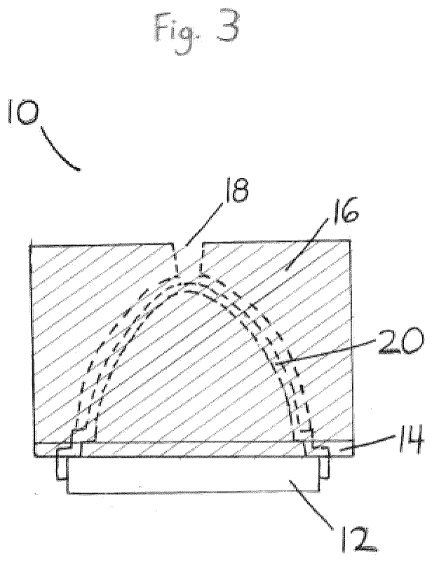

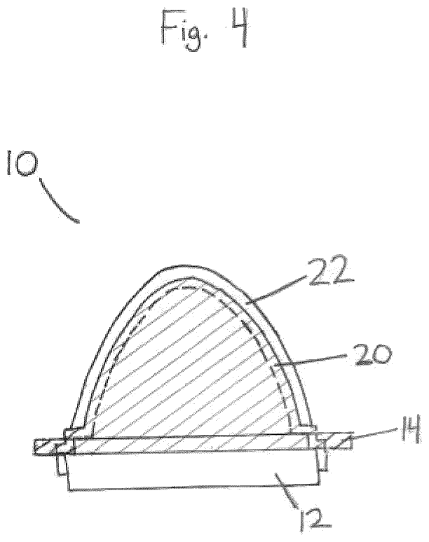

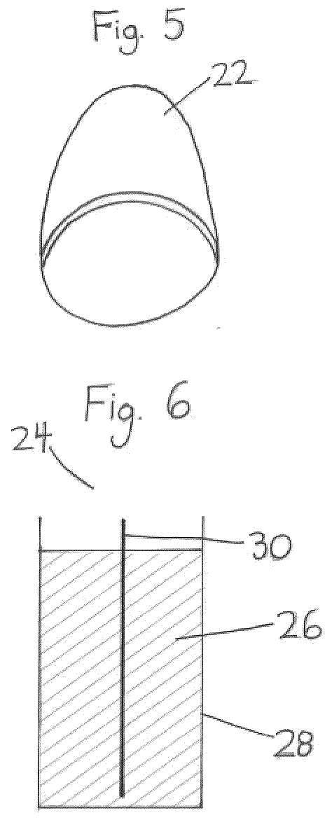

Referring to FIGS. 1-4, a mold 10 that can be configured for making a re-purposable biodegradable snack container is shown. The mold 10 can include a core 12, a ring 14 that can be configured to surround the core 12, a cover 16 configured to cover the core 12 and comprising a hole 18 and a non-stick material 20. The mold 10 can be configured to receive a material to create a container 22 as shown in FIG. 5 with the material. The container 22 can be a re-purposable biodegradable snack container. In some embodiments, the mold 10 can be a mold 10 configured for injection molding. In some embodiments, the mold 10 can be a blow mold 10, compression mold 10, rotational mold 10, or other mold 10 based. In some embodiments, the mold can comprise a metal material.

As shown in FIG. 1, the core 12 can have a prolate spheroid shaped or “egg shaped” protrusion extending from a body of the core 12. In some embodiments of the present disclosure, the protrusion can have a rectangular shape, a triangular shape, a spherical shape and/or other shape. In some embodiments of the present disclosure, the shape of the container 22 can correspond to the shape of the protrusion of the core 12. In some embodiments of the present disclosure, it can be preferable to cover and/or coat the core 12 with a non-stick material and/or coating 20. This can help with removing the container 22 from the mold 10 when the container 22 is finished curing in the mold 10. In some embodiments of the present disclosure the non-stick material 20 can be aluminum foil. In some embodiments, the core 12 can be made of a non-stick material, for example, polytetrafluoroethylene (PTFE).

The ring 14 can have an annular shape defining an opening which can be configured to surround the core 12 such that the ring 14 may abut the base of the core 12. In some embodiments, the ring 14 may have an opening that can be shaped to correspond to the shape of the protrusion of the core 12 such that the protrusion of the core 12 can slide through the opening of the ring 14 such that the ring 14 abuts the base of the core 12. For example, if the protrusion of the core 12 comprises a rectangular shape, the ring 14 can have a square or rectangular opening. The ring 14 can comprise a groove 32. In some embodiments of the present disclosure, the groove 32 can be a single indented groove 32 arranged circumferentially around the surface of the ring 14. In some embodiments, the groove 32 can be a plurality of disconnected grooves 32 arranged circumferentially around the surface of the ring 14. In some embodiments, the thickness of the groove 32 may be less than the thickness of the ring 14.

The cover 16 can extend from a first end to a second end and can comprise a raised surface 34 at the first end and a hole 18 at the second end configured to receive the material, preferably a liquid material, into the mold 10. The raised surface 34 can be a single raised surface 34 arranged circumferentially around the first end and can comprise a shape corresponding to the groove 32 of the ring 14 such that the raised surface 34 can be configured to insert into the groove 32 to removably couple the cover 16 to the ring 14. In some embodiments, the raised surface 34 can be a plurality of disconnected raised surfaces 34 arranged circumferentially around the first end and can comprise a shape corresponding to the groove 32 of the ring 14 such that the plurality of raised surfaces 34 can be configured to insert into the plurality of grooves 32 to removably couples the cover 16 to the ring 14. In some embodiments, the raised surface 34 may couple with the groove 32 with an interference fit. In some embodiments, the raised surface 34 may couple with the groove 32 with an adhesive material on the raised surface 34 and/or in the groove 32. In some embodiments, the raised surface 34 may couple with the groove 32 using hook and loop fasteners. In some embodiments, the raised surface 34 may couple with the groove 32 with magnets. The aforementioned coupling options are meant to be illustrative and should not serve to limit the scope of the present disclosure. The cover 16 can include a recess. In some embodiments, the recess can correspond to the shape of the protrusion of the core 12 such that the protrusion of the core 12 can be inserted into the recess. Placing the cover 16 on the core 12 can form a tight seal over the core 12 and can cause the core 12 to be substantially sealed from the outside environment. Covering the core 12 with the cover 16 can provide the material with protection from outside contaminants and can provide the material with support while it cures and can prevent the material from leaking out of the mold 10 while it cures.

The hole 18 can be configured to provide access to the core 12 or interior of the mold 10 when the cover 16 has been placed over the core 12. For example, in some embodiments, the hole 18 can be configured to receive a material, preferably a liquid material, to be inserted into the mold 10. In some embodiments, the material inserted into the hole 18 can be liquid candle wax. In some embodiments, the liquid candle wax can be paraffin wax, beeswax, soy wax, candelilla wax, carnauba wax, and/or coconut wax. In some embodiments, the material can be a mixture of liquid candle wax and a hardening additive. The hardening additive can cause the liquid candle wax to be made harder and more durable when the liquid candle wax has cured. In some embodiments, the hardening additive can be steric acid and/or vybar. In some embodiments, the hardening additive can be some other type of biodegradable and/or plant-based hardening additive. In some embodiments, the hardening additive may be a two percent hardening additive. In some embodiments, the hardening additive may be a less than two percent hardening additive. In some embodiments, the material can be a mixture of liquid candle wax and a diluting agent. The diluting agent can cause the liquid candle wax to be diluted if the liquid candle wax is too hard and brittle after the liquid candle wax has cured. In some embodiments, the diluting agent can be coconut oil. In some embodiments, the diluting agent can be some other type of biodegradable and/or plant-based dilutant. In some embodiments, the diluting agent may be forty percent dilutant. In some embodiments, the diluting agent may be greater than forty percent dilutant. In some embodiments, the diluting agent may be less than forty percent dilutant. In some embodiments, the material can include a fragrance oil, essential oil, and/or other fragrance such that the material can be scented. In some embodiments, a dye and/or colorant can be added to the material to provide a desired color to the material. After inserting the material into the mold 10 via the hole 18, the material can be left in the mold 10 until it cures, forming the container 22. When the material cures, the container 22 may be in a solid state, or a “packaging” state, in which the container 22 may enclose or store an item, for example, a food and/or snack. In some embodiments, the material can take 8-12 hours to cure. In some embodiments, it may take less than 8 hours for the material to cure. In some embodiments, it may take more than 12 hours for the material to cure. In some embodiments, a plug can be inserted into the hole 18. In some embodiments, a handle configured to help remove the cover 16 from the mold 10 can be inserted into the hole 18.

FIG. 5 shows an embodiment of a container 22 that can be made using the mold 10 described herein. The container 22 made with the mold 10 can have a shape that corresponds to the shape of the mold 10. For example, the container 22 of FIG. 5 has a prolate spheroid or “egg” shape and could have been made with a mold 10 having a prolate spheroid shape. In some embodiments, the mold 10 can make a container 22 that is unified and can be decoupled into two or more pieces. In some embodiments, the mold 10 can make a single piece of a container 22 that can be coupled with one or more additional pieces to form the container 22. In some embodiments the two or more pieces of the container 22 can be removably coupled together with, for example, an interference fit. In some embodiments, the two or more pieces of the container 22 can be removably coupled together using an adhesive. In some embodiments, the adhesive can be freezeproof. In some embodiments, the container 22 can alternate between a first position or open position in which the container 22 can be configured to receive an item or for allowing a user to retrieve an item stored in the container 22, for example, a snack, and a second position or closed position in which the container 22 can be configured to store an item, for example, a snack, and can protect the item from outside contamination. In some embodiments, the container 22 storing an item can be stored in, for example, a refrigerator, a freezer, a cooler and/or other preservation device to further protect and/or preserve the item stored in the container 22. In some embodiments, coupling or decoupling the pieces of the container 22 can change the container 22 from the first position to the second position or the second position to the first position. In some embodiments, the container 22 can be a food-grade container. In some embodiments, the container 22 can be repurposed, for example, as a candle 24. In some embodiments, the container 22 can be biodegradable. In some embodiments, the container 22 can be made cruelty-free.

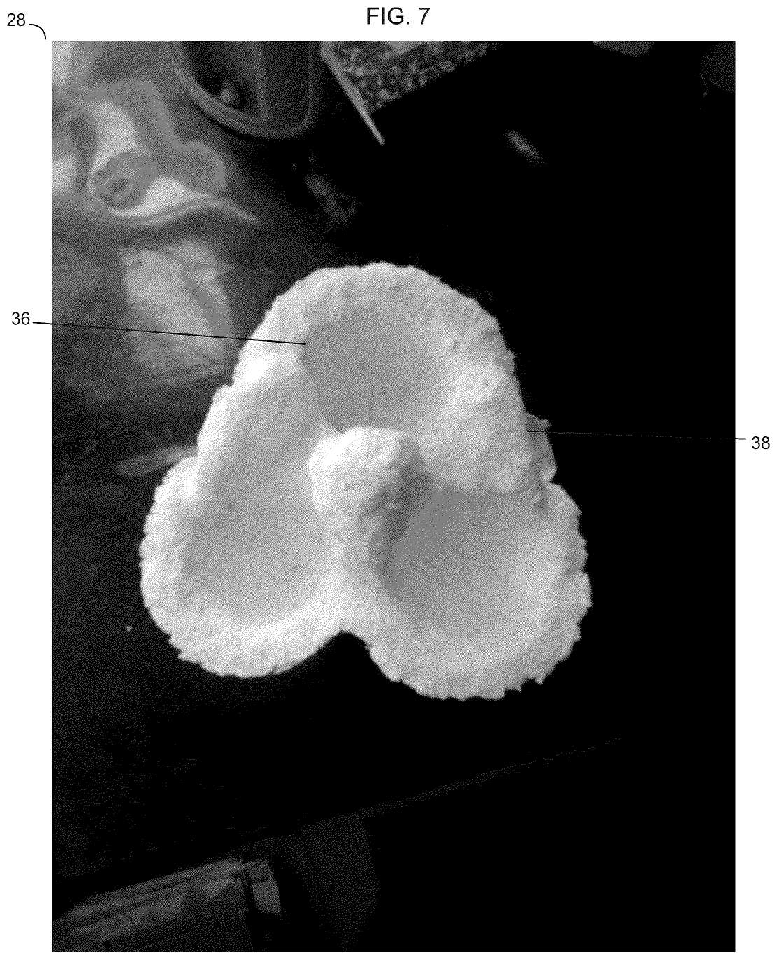

FIG. 6 shows an embodiment of a vessel 28. The vessel 28 can be configured as a holder for a candle 24 that can comprise candle wax 26 and a wick 30 that is formed by repurposing the container 22 with the methods described herein. The vessel 28 can be any type of receptacle suitable for holding liquid candle wax and solid candle wax. For example, in some embodiments, the vessel 28 can be a carton. In some embodiments, the vessel 28 can be a glass container. In some embodiments, the vessel 28 can comprise a single piece. In some embodiments, the vessel 28 can comprise two or more pieces, such as, for example, a base 38 and a top 40 (see FIGS. 7-9). In some embodiments, the wick 30 can be releasably coupled to the vessel 28 such that, for example, the wick 30 can be removed from the vessel 28 to be submerged in the candle wax 26, preferably when the candle wax 26 is in a liquid state. In some embodiments, the vessel 28 can comprise a biodegradable material, such as sugarcane bagasse, paper pulp, polylactic acid (PLA), bamboo, coconut shell, hemp and flax fibers, jute or sisal, mycelium composite, a calcium alginate-based bioplastic, a starch-based foam, polyhydroxyalkanoates (PHA), a starch-based bioplastic, cellulose acetate, an algae-based bioplastic and/or other biodegradable material.

In some embodiments, the vessel 28 can comprise a leakproof material. In some embodiments, the material of the vessel 28 can be treated with one or more coatings. In some embodiments, the coating can comprise chitosan, beeswax, carnauba wax, starch-based coatings, PLA and/or PHA, lignin-based coatings, cellulose acetate, soy wax, shellac, and/or linseed oil. In some embodiments the coating can improve the resistance of the vessel 28 to liquids. In some embodiments, the material of the vessel 28 can be infused with liquid-resistant additives, preferably a biodegradable and/or eco-friendly liquid-resistant additive, for example, chitosan, silicon dioxide, calcium carbonate, cellulose nanofiber, cellulose acetate, PLA and/or PHA, and/or glycerol. In some embodiments the additive and/or coating can improve the durability of vessel 28. In some embodiments, the coating can improve the fireproofing of vessel 28. In some embodiments, the vessel 28 can be treated on an interior side of the vessel 28 to improve one or more of the aforementioned characteristics and/or properties (e.g., fireproof) and can be treated on an exterior side of the vessel 28 to improve a different of the aforementioned characteristics and/or properties (e.g., waterproof). In some embodiments, the interior side of the vessel 28 can be treated without treating the exterior side of the vessel 28 and vice versa. In some embodiments, multiple coatings of different materials can be used to treat the vessel 28 (e.g., both a coating to waterproof the vessel 28 and a coating to fireproof the vessel 28). In some embodiments, the vessel 28 may comprise a fireproof material, for example, mycelium composite. In some embodiments, the vessel 28 may be coated with a fireproof resin. In some embodiments, the material of the vessel 28 can be infused with fire retardants, preferably a biodegradable and/or eco-friendly fire retardants, for example, sodium borate, ammonium phosphate, aluminum hydroxide, magnesium hydroxide, biochar, phytic acid, wollastonite, tannic acid, lignin, clay or natural silica additives, and/or natural plant resins. In some embodiments, the vessel 28 may comprise paper pulp. In some embodiments, the vessel 28 can comprise sugarcane bagasse material with a magnesium hydroxide fire-resistant additive and calcium carbonate liquid-resistant additive and a binder. In some embodiments, the binder could be a starch such as cornstarch. In some embodiments, the vessel 28 can be heart shaped. In some embodiments, the vessel 28 may have a top 40 comprised of paper pulp. In some embodiments, the paper pulp can be bleached and/or dyed to match a label and/or logo applied to top 40.

In embodiments where the vessel 28 comprises two or more pieces, one or more of the pieces may be treated as described herein to be fireproof and/or leakproof while one or more of the remaining pieces are not treated. For example, in embodiments where the vessel 28 comprises a base 38 and a top 40, the base 38 may be fireproof and/or leakproof while the top 40 may not be fireproof and/or leakproof. In some embodiments where the vessel 28 comprises two or more pieces, all the pieces may be fireproof and/or leakproof.

FIG. 7 shows an embodiment of the vessel 28 configured as a carton comprising a base 38 and three recesses 36. Although the vessel 28 is shown having three recesses 36, it should be appreciated that in other embodiments, the vessel 28 can comprise more than three recesses 36 or two or fewer recesses 36. Although the vessel 28 is shown having recesses 36 in the base 38, in other embodiments where the vessel 28 comprises a top piece 40, the vessel 28 may comprise recesses 36 in the top piece 40. The recesses 36 can be configured to receive the candle wax 26 discussed herein. For example, in some embodiments, the recesses 36 can receive the candle wax 26 in a liquid state. The liquid candle wax 26 can then remain in the recesses 36 until it cures into solid candle wax 26. In some embodiments, the recesses 36 may first receive the candle wax 26 when the candle wax 26 is in the solid state. In some embodiments, the recesses 36 may receive the container 22, for example, while the container 22 is in the solid state and/or the packaging state.

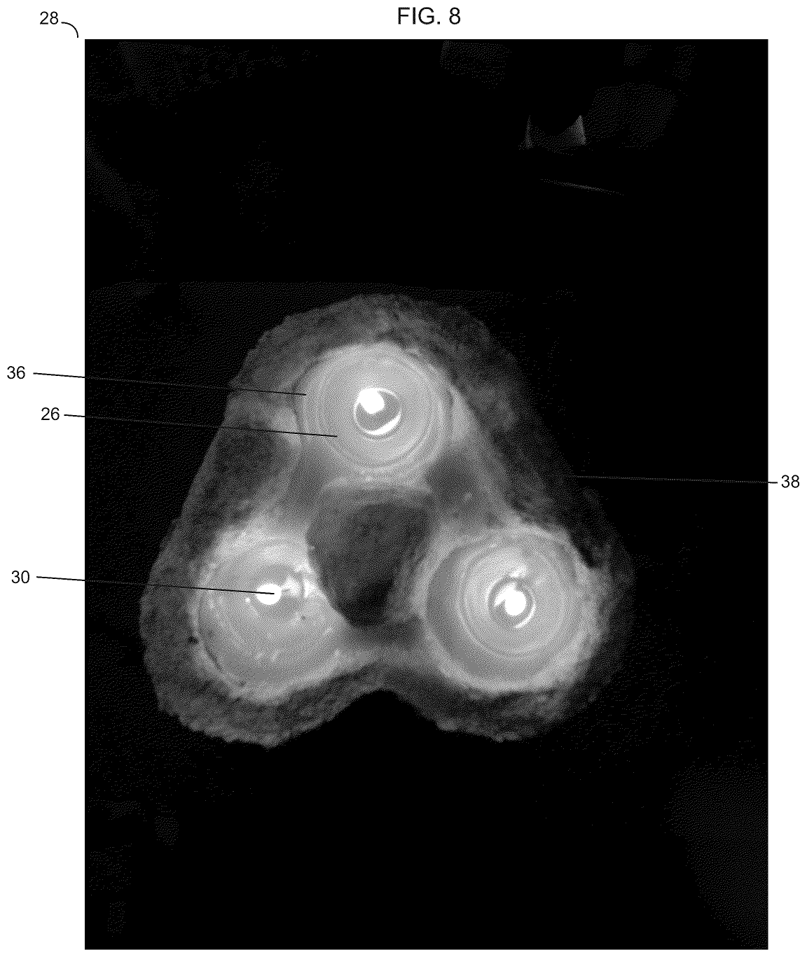

FIG. 8, shows an embodiment of the vessel 28 of FIG. 7 with candle wax 26 in the recesses 36 of the base 38. Specifically, FIG. 8 shows the candle wax 26 in a solid state in the recesses 36 with a wick 30. In some embodiments, the wick 30 can be lit with, for example, a match. It should be appreciated that although the base 38 is shown with candle wax 26 in each of the three recesses 36 of the base 38, the candle wax 26 need not be placed in all the recesses 36 of the base 38. For example, in embodiments of the vessel 28 in which the base 38 comprises three recesses 36, it is possible that candle wax 26 is inserted into only one recess 36, into two recesses 36, or into none of the recesses 36.

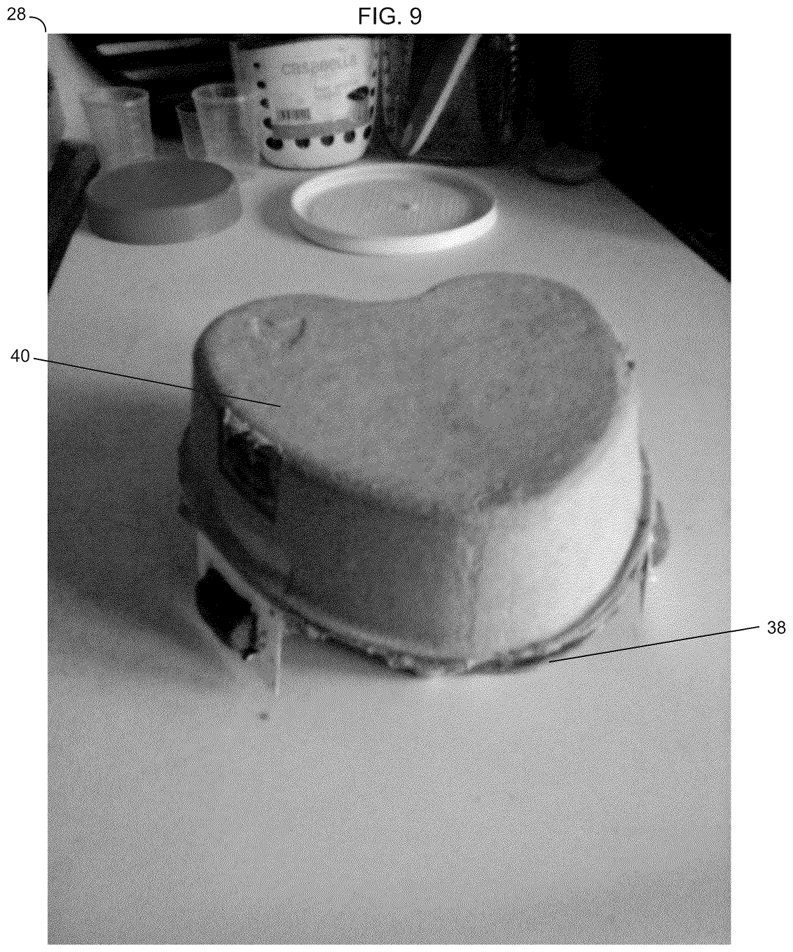

FIG. 9 shows an embodiment of the vessel 28 of FIG. 7 and FIG. 8 comprising two pieces, a base 38 and a top 40. In embodiments of the vessel 28 comprising the top 40, the top 40 can be used, for example, to cover and/or seal the vessel 28, for example, while the candle wax 26 cures.

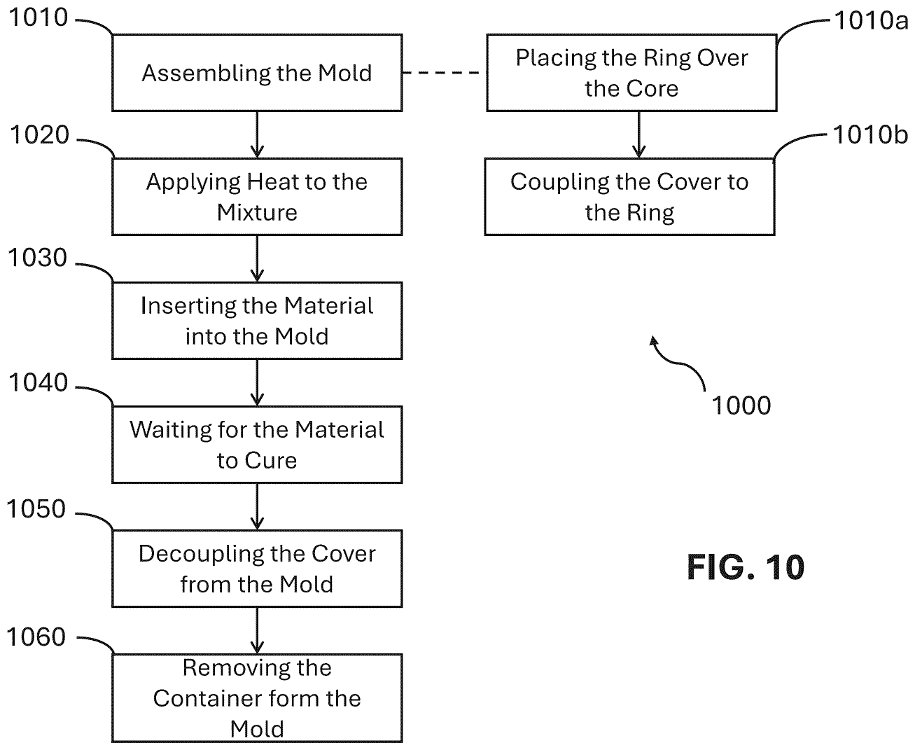

FIG. 10 shows a flow chart of an example embodiment of a method for making a container 22 with the mold 10. In a first assembling step 1010, a user can assemble the mold 10. The first step 1010 can comprise sub-steps 1010a and 1010b. Sub-step 1010a can include placing the ring 14 having an annular shape defining an opening and comprising a groove 32 over the core 12. Sub-step 1010b can include coupling the cover 16 to the ring 14 by inserting the raised surface 34 of the cover 16 into the groove 32 of the ring 14. In some embodiments, step 1010 may further comprise an additional sub-step that can include aligning a non-stick material 20 over the core 12 and/or coating the core 12 with a non-stick material 20.

In a heating step 1020, the user can apply heat to a mixture comprising at least candle wax to form the material to insert into the mold. In some embodiments the mixture may additionally comprise a hardening additive. For example, in some embodiments, the user can apply heat to the mixture using a microwave, a stovetop and/or other heating device. The user may adjust the duration and intensity of the heating of the mixture depending on the type of material used in the mixture.

In an inserting step 1030, the user can insert the material into the mold 10. In some embodiments, inserting the material into the mold 10 can comprise inserting the material into the mold 10 via the hole 18.

In a curing step 1040, the user can wait for the material to cure into the container 22 in the mold 10. In some embodiments, the material can cure for 8-12 hours.

In a decoupling step 1050, the user can decouple the cover 16 from the mold 10. Decoupling the cover 16 from the mold 10 can comprise removing the raised surface 34 of the cover 16 from the groove 32 of the ring 14.

In a final removing step 1060, the user can remove the container 22 from the mold 10.

In some embodiments, the method 1000 can further comprise applying an adhesive to the container 22. In some embodiments, the method 1000 can further comprise storing an item, for example a snack or food, in the container 22. The container 22 may comprise a food-grade and/or food-safe material.

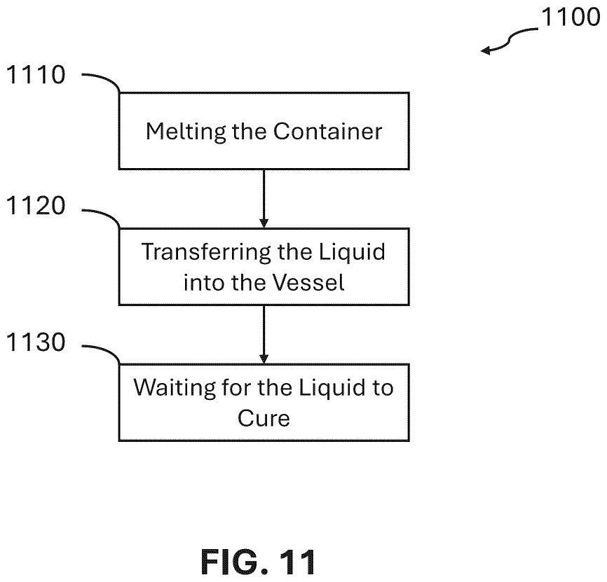

FIG. 11 shows a flow chart of an example embodiment of a method 1100 for repurposing the container 22 for use as a candle 24. In a first melting step 1110, the container 22 can be melted. In some embodiments, the container 22 can be placed in a receptacle prior to melting the container 22. In some embodiments, the container 22 can be decoupled into pieces and each piece can be placed in a separate receptacle. In such embodiments, decoupling the container 22 can comprise removing an adhesive on the container 22. In some embodiments, melting the container 22 can comprise placing a receptacle containing the container 22 or a piece of the container 22 in a microwave and applying microwaves to the container 22. In some embodiments, melting the container 22 can comprise placing the container 22 or a piece of the container 22 in the vessel 28, placing the container 22 and the vessel 28 in a microwave and applying microwaves to the container 22 and vessel 28.

In a transferring step 1120, the melted container 22, which can be liquid candle wax 26 can be poured into the vessel 28. In some embodiments, the candle wax 26 can be a type of wax that is in the liquid state at an elevated temperature and solidifies as it approaches room temperature. For example, the candle wax 26 can be paraffin wax, beeswax, soy wax, candelilla wax, carnauba wax, coconut wax, and/or a combination of waxes.

In a final curing step 1130, the user can wait for the liquid candle wax 26 to cure in the vessel 28. In some embodiments, the liquid candle wax 26 can cure for 8-12 hours. In some embodiments, the liquid candle wax 26 can cure by placing the liquid candle wax 26 at room temperature. In some embodiments, the user may use cooling devices, for example, a refrigerator, to speed up the curing process.

In some embodiments, the method 1100 can further comprise adding the wick 30 into the liquid candle wax 26 shortly after transferring the liquid candle wax 26 into the vessel 28 in step 804 by, for example, submerging the wick 30 into the liquid candle wax 26. In some embodiments, the wick is preferably added to the liquid candle wax 26 eight minutes after transferring to the vessel 28. In some embodiments, the method 1100 can further comprise igniting the wick 30.

The detailed description herein is directed to certain embodiments of systems and methods relating to a re-purposable container, and related features. In this description, reference is made to the accompanying drawings. In the drawings, similar symbols typically identify similar components, unless context dictates otherwise. Thus, in some embodiments, part numbers may be used for similar components in multiple figures, or part numbers may vary from figure to figure. The illustrative embodiments described herein are not meant to be limiting. Other embodiments may be utilized, and other changes may be made, without departing from the spirit or scope of the subject matter presented. It will be readily understood that the aspects of the present disclosure and illustrated in the figures can be arranged, substituted, combined, and designed in a wide variety of different configurations by a person of ordinary skill in the art, all of which are made part of this disclosure.

Reference in the specification to “one embodiment,” “an embodiment”, or “in some embodiments” means that a particular feature, structure, or characteristic described in connection with the embodiment is included in at least one embodiment of the disclosure. Moreover, the appearance of these or similar phrases throughout the specification does not necessarily mean that these phrases all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

The foregoing description details certain embodiments of the systems, devices, and methods disclosed herein. It will be appreciated, however, that no matter how detailed the foregoing appears in text, the systems and methods can be practiced in many ways. It should be noted that the use of particular terminology when describing certain features or aspects of the disclosure should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The term “comprising” as used herein is synonymous with “including,” “containing,” or “characterized by,” and is inclusive or open-ended and does not exclude additional, unrecited elements or method steps.

The above description discloses several methods and materials of the present disclosure. This disclosure is susceptible to modifications in the methods and materials, as well as alterations in the fabrication methods and equipment. Such modifications will become apparent to those skilled in the art from a consideration of this disclosure or practice of the embodiments disclosed herein. Consequently, it is not intended that this disclosure be limited to the specific embodiments disclosed herein, but that it cover all modifications and alternatives coming within the true scope and spirit of the disclosure as embodied in the attached claims.

What is claimed is:

1. A re-purposable container system comprising:
a container;
a vessel configured to house the container, the vessel comprising:
a bottom piece comprising one or more recesses configured to receive the container while the container is in a liquid state; and
a top piece abutting the bottom piece;
a wick releasably coupled to the vessel and configured to release from the vessel and submerge in the container while the container is in the liquid state.

2. The system of claim 1, wherein the container, the vessel and the wick comprise a biodegradable material.

3. The system of claim 2, wherein the base comprises at least one of a fire-resistant material and a fire-resistant additive.

4. The system of claim 2, wherein the base comprises a leak-resistant material.

5. The system of claim 2, wherein the vessel is configured to receive the container while the container is in the liquid state and to house the container in the liquid state while the container in the liquid state cures.

6. The system of claim 1, wherein the container is in a non-liquid packaging state, prior to being in the liquid state.

7. The system of claim 6, wherein the vessel is further configured to package the container in the packaging state.

8. The system of claim 7, wherein the container comprises a food-safe material suitable for packaging an edible product.

9. The system of claim 1, wherein the container comprises a first piece and a second piece and the container further comprises an adhesive which comprises a first adhesive end coupled to the first piece and a second adhesive end coupled to the second piece and is configured as a hinge such that the first piece and the second piece are configured to move between a closed position and an open position.

10. The system of claim 2, wherein the container comprises a diluting agent.

11. A method for repurposing a re-purposable container, the method comprising:
melting a re-purposable container into a liquid;
transferring the liquid into a vessel; and
waiting for the liquid to cure.

12. The method of claim 11, further comprising submerging a wick in the liquid.

13. The method of claim 12, further comprising igniting the wick.

14. The method of claim 13, further comprising treating a base of the vessel with a solution comprising a fire-resistant additive.

15. The method of claim 13 further comprising treating a base of the vessel with a solution comprising a leak-resistant additive.

16. The method of claim 11, wherein the re-purposable container is in a non-liquid packaging state prior to melting into the liquid state.

17. The method of claim 16, further comprising packaging the re-purposable container in the packaging state with the vessel.

18. The method of claim 17, wherein the re-purposable container comprises a food-safe material suitable for packaging an edible product.

19. The method of claim 18, wherein the container comprises a first piece and a second piece and the container further comprises an adhesive which comprises a first adhesive end coupled to the first piece and a second adhesive end coupled to the second piece and is configured as a hinge such that the first piece and the second piece are configured to move between a closed position and an open position, and wherein the method further comprises storing the edible product in the container in the open position and transitioning the container between the open position and the closed position.

20. The method of claim 13, further comprising treating the container with a diluting agent.
